(19) United States
(12) Patent Application Publication
(10) Pub. No.: US 2022/0053708 A1
(43) Pub. Date: Feb. 24, 2022

(54) DRAINAGE AND AERATION DEVICE FOR PLANT CONTAINERS

(71) Applicant: Robert Douglas Koren, Cary, NC (US)

(72) Inventor: Robert Douglas Koren, Cary, NC (US)

(21) Appl. No.: 17/001,076

(22) Filed: Aug. 24, 2020

(51) Int. Cl. A01G 9/02; A01G 9/04

(52) U.S. Cl. CPC A01G 9/02; A01G 9/04

(57) ABSTRACT

A drain shield for a plant container prevents compaction of soil, maintain drainage and provide for aeration of the roots of the plant. The drain shield comprises a unitary molded disk with a plurality of cube-like supports which are circumferentially spaced near the perimeter of the disk. The supports are positioned inward from the outer edge of the disk creating an eave around the perimeter of the disk that overhangs the supports. When the disk is placed on the bottom of a plant container, the supports form a series of uniform passages that lead to an unobstructed inner space under the disk. The side walls of the supports, as they relate to each other and to the center of the disk, are tapered in such a way that the passages between adjacent supports becomes larger toward the center of the disk. The underside of the disk, and to the inward side of the supports, is concave, forming a dome.

### TECHNICAL FIELD

The present disclosure relates generally to plant containers, such as planters and pots, for flowers and other plants and, more particularly, to drainage systems for plant containers to maintain proper drainage and aeration of plants.

### BACKGROUND

Gardeners have been cultivating plants in various containers for millennia. The majority of planters and pots of average size and larger, available at garden centers and discount stores, come with a single drain hole in the bottom. This single hole configuration, especially when small in relation to the volume of the container, has proven to be inadequate leading to drainage issues.

Maintaining proper hydration levels in the container is critical for optimum plant health. When the plant is watered, the water is directed to a single opening. Soil and organic material is carried toward the hole by the water, leading to compaction of the soil and plugging of the drainage hole. Over-saturated soil leads to an issue known as root rot, which can be difficult to remedy and usually results in the plant dying.

A common suggestion to avoid over-saturation is to drill additional holes in the bottom; however, this solution is not an option due to the likelihood of damaging or cracking the planter. Another long-standing practice is to place broken shards of clay pots over the drain hole creating passages under the compressed soil for the water to egress. The nature of placing random shards over the drain hole yields inconsistent result making it difficult to establish a system for assembling and maintaining a diverse array of plants.

Recently, much research has been conducted to determine the most effective methods and materials to be used to achieve optimum drainage and plant health in a plant container. Much of the research has defied conventional wisdom. For example, one common practice is putting rocks in the bottom of a planter, under a layer of planting mix to expedite drainage of water from the planter. Research has shown the water actual does not migrate into the rocks as one would expect. Rather, the soil fills the interstitial gaps in the rocks and water pools on top of the rocks so that the soil remains saturated.

When one incurs the considerable cost of assembling a planter, enjoying the restorative benefits of working with thriving plants is the goal.

### SUMMARY

The present disclosure comprises a drain shield to a plant container to prevent compaction of soil, maintain drainage and provide for aeration of the roots of the plant. The drain shield comprises a unitary molded disk with a plurality of cube-like supports which are circumferentially spaced near the perimeter of the disk. The supports are positioned inward from the outer edge of the disk creating an eave around the perimeter of the disk that overhangs the supports. When the disk is placed on the bottom of a plant container, the supports form a series of uniform passages that lead to an unobstructed inner space under the disk. The side walls of the supports, as they relate to each other and to the center of the disk, are tapered in such a way that the passages between adjacent supports becomes larger toward the center of the disk. The underside of the disk, and to the inward side of the supports, is concave, forming a dome.

### BRIEF DESCRIPTION OF THE DRAWINGS

FIG. 1 is a perspective view of the container system for plants including a plant container, a drain pan and a drain shield.

FIG. 2 is a perspective view of the container system partially cut-way to show the drain shield.

FIG. 3 is a partial section view of the plant container system.

FIG. 4 is a perspective of the drain shield from above.

FIG. 5 is a bottom view of the drain shield.

FIG. 6 is a top view of the drain shield.

FIG. 7 is a side view of the drain shield.

FIG. 8 is a section view of the drain shield taken though line VIII-VIII in FIG. 5.

FIG. 9 is a perspective of the drain shield from below.

### DETAILED DESCRIPTION

The present disclosure relates to a drain shield for use with plant containers to prevent compaction of soil, maintain drainage and provide for aeration of the roots of the plant. The drain shield is placed on the bottom of the plant container before soil or planting mix is added to the plant container and covers the drain hole in the bottom of the container. Soil or planting mix is then added to cover the drain shield and fill the plant container. The drain shield prevents soil compaction in the drain hole and provides passages for the egress of water from the plant container. The same passages improve aeration of the roots of the plant by providing a pathway for the ingress of air.

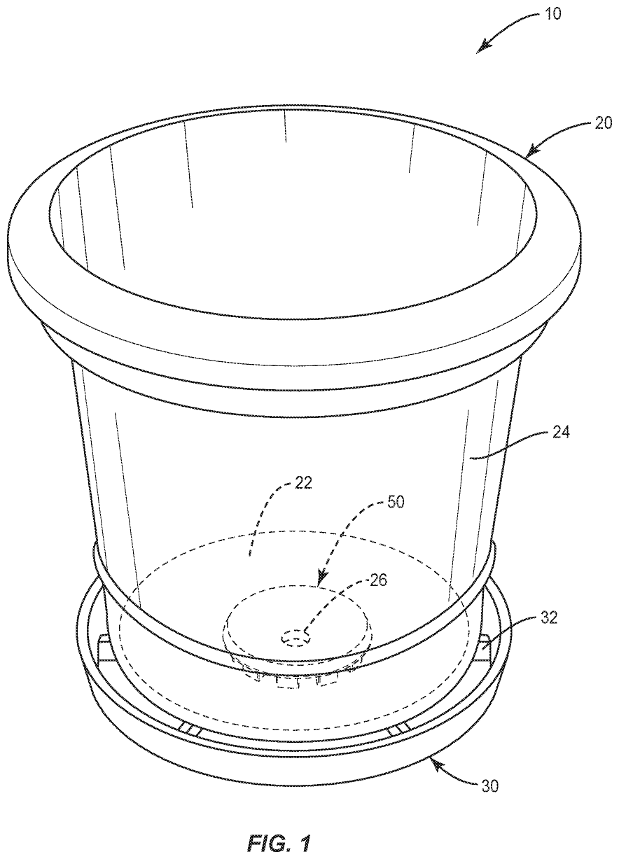

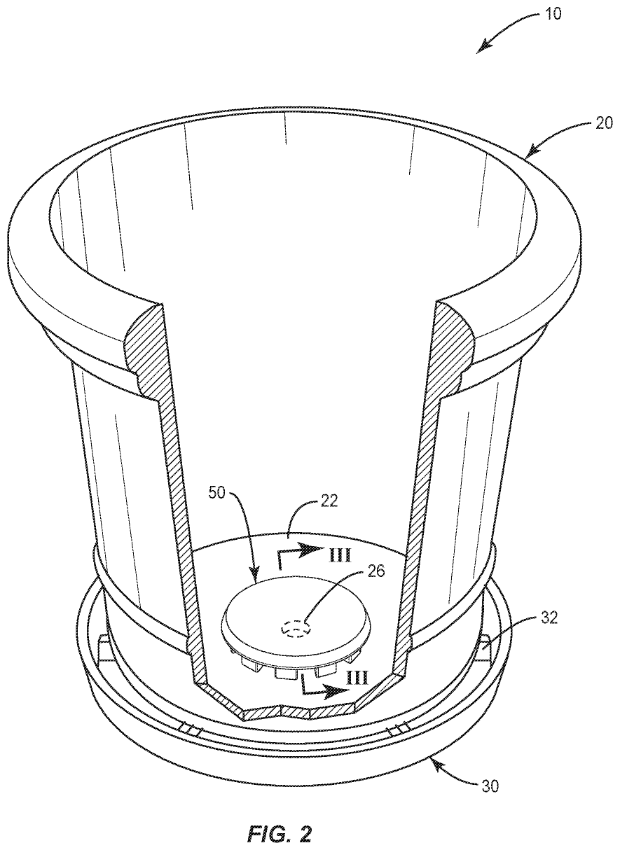

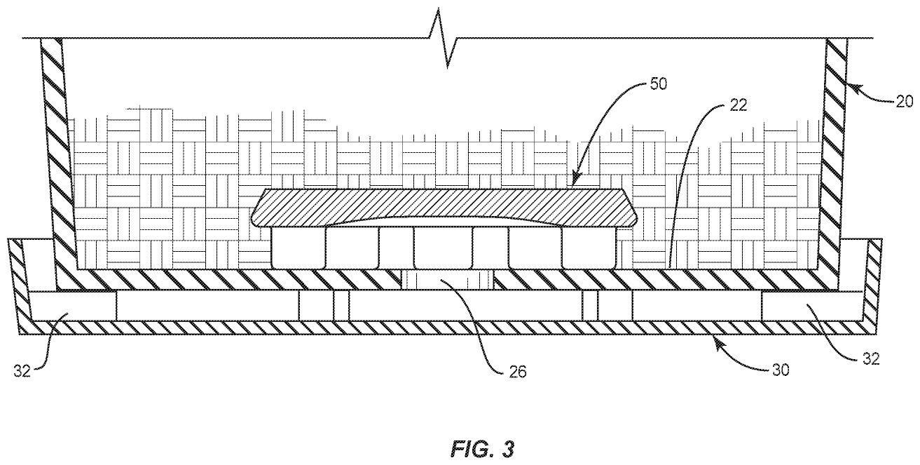

FIGS. 1-3 illustrate a plant container system 10 for cultivating flowers or other plants. The plant container system 10 comprises three main components: a plant container 20, a drain pan 30 (also known as a saucer) and a drain shield 50. The plant container 20 comprises may comprise a planter or pot configured to contain a medium (e.g., potting mix or soil) for growing plants. In the exemplary embodiment shown in FIG. 1, the plant container 20 comprises a pot having a flat bottom 22 and tapered sidewall 24. The bottom 22 includes a drain hole 26 allowing excess water to drain from the pot to prevent over-saturation of the plant roots. The drain pan 30 comprises a shallow dish designed to catch the excess water that drains from the plant container 20. The bottom surface of the drain pan 30 typically includes a series of ribs to raise the plant container 20 slightly above the bottom of the drain pan 30 thus allowing excess water to drain and air to enter the drain hole. The drain shield is placed inside the plant container 20 to cover the drain hole before the growing medium is added to the plant container 20. The primary purpose of the drain shield is to maintain good drainage and aeration as hereinafter described.

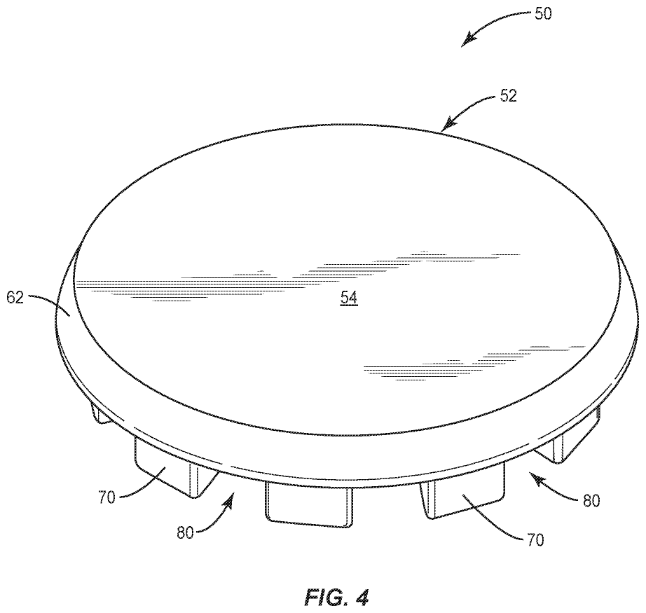

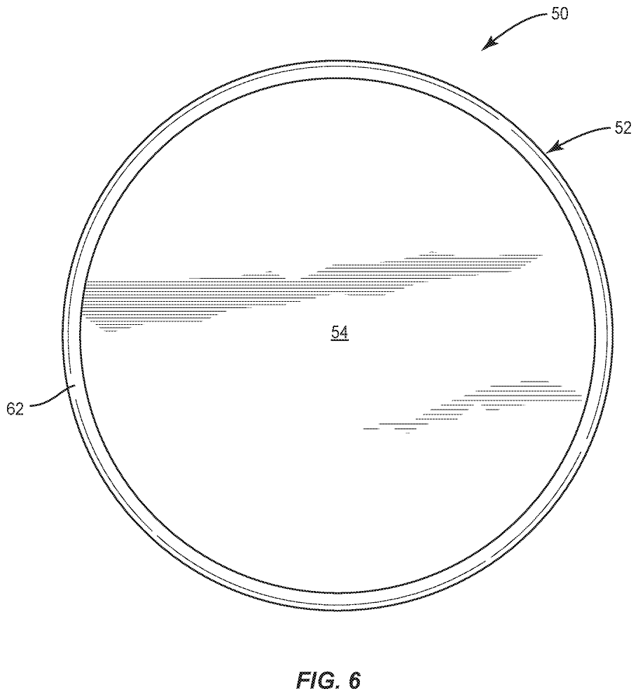

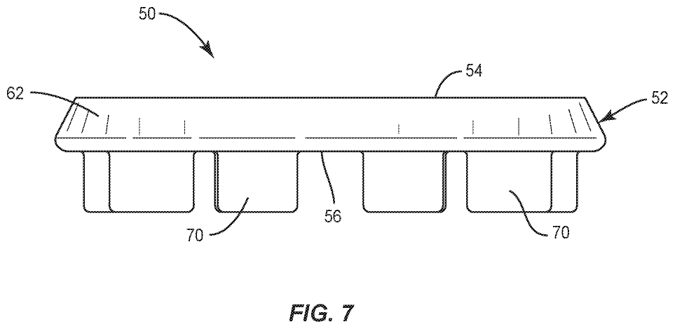

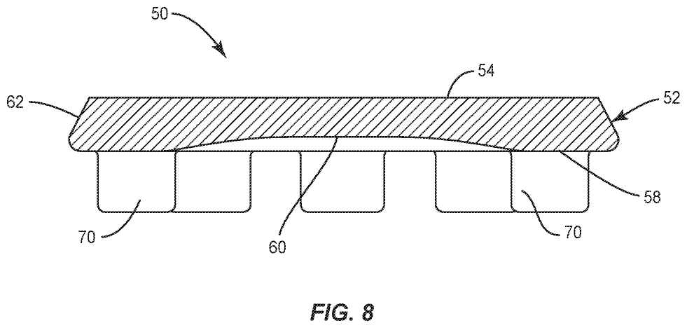

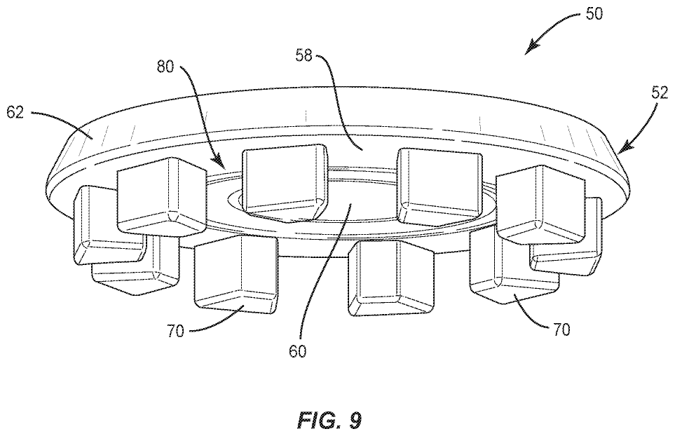

FIGS. 4-9 illustrate an exemplary embodiment of the drain shield 50. The drain shield 50 comprises a cover plate 52 and a plurality of supports 70 spaced along the periphery of the cover plate 52. When the drain shield 50 is placed in a plant container 20, the supports 70 support the cover plate 52 in spaced relation to the bottom of the plant container 20 so that a domed chamber is formed beneath the cover plate 52 and passages 80 leading into the chamber are formed between the supports 70. The passages 80 allow the egress of water and ingress of air. In some embodiments, a mesh material (not shown) can be placed in the chamber.

In one embodiment, the cover plate 52 is generally circular in form and has a top surface 54 and a bottom surface 56. The top surface 54 of the cover plate 52 is substantially flat. The bottom surface 56 includes a generally flat outer region 58 adjacent the outer edge of the cover plate 52 and a concave central region 60 that forms a dome on the underside of the cover plate 52. The side edge 62 of the cover plate 52 is slightly angled so that soil is pushed outward

The supports 70 are circumferentially spaced and extend downward from the outer region 58 of the bottom surface 56. The bottom end of the supports 70 should allow positive contact with the bottom surface of most plant containers 20, whether the bottom is flat, concave, or even slightly convex.

The supports 70 are spaced inwardly from the outer edge of the cover plate 52 so that the cover plate 52 forms an eave that overhangs the supports 70. The function of the eave is two-fold. The first relates to the initial assembly of the plant container 20 when the potting mix is added. Several steps in the planting process require pressing the plant and potting mix down into the plant container 20. The overhang or eave provided by the cover plate 52, along with the tapered side edge 62 of the cover plate 52, ensures that compression of the potting mix during the assembly does not cause compaction of potting mix in the passages between the supports 70. Instead, the structure of the cover plate 52 pushes the potting mix away from the passages 80. The second function relates to the water flow over the eave. Water cannot penetrate the cover plate 52 so the water is diverted to the outer edges and over the eave, creating a beneficial flow of water through the passages 80 that will help wash fine particles out through the drain hole in the plant container.

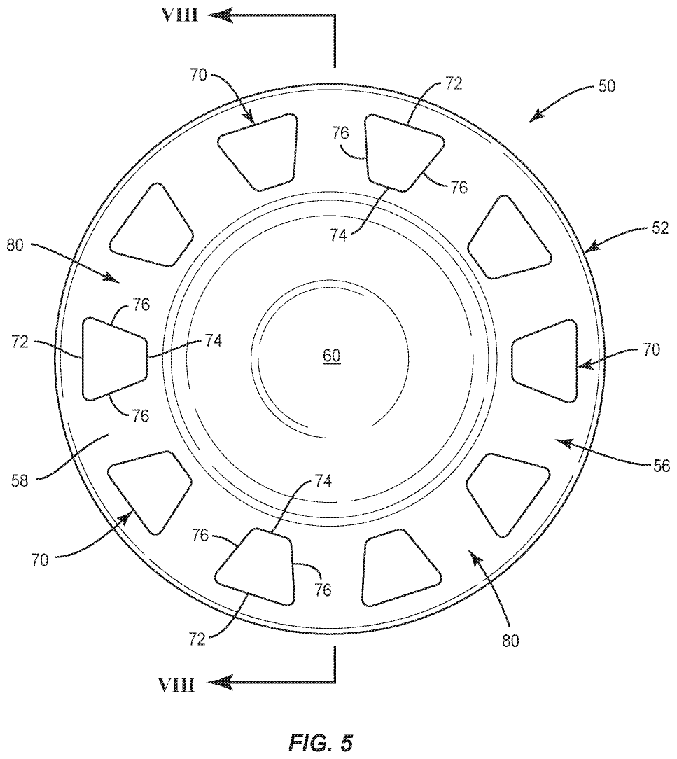

In one embodiment, the supports 70 are trapezoidal in shape as shown in FIG. 5. Each support 30 includes an outer face 72, an inner face 74 and side faces 76. The outer faces 72 of the supports 70 are flat. In use, the growing medium accumulating in front of the supports 70 help in directing the flow of water through the passages 80 between the supports 70. The side faces 76 of the supports 70 that face each other are flat and tapered in such a way that the passage 80 between two adjacent supports 70 becomes larger towards the center of the drain shield 50, i.e. from the inlet end to the outlet end. The tapering of the side faces 76 ensures that any soil or potting mix entering the passage 80 can pass through the passage 80 without becoming trapped or compacted.

The drain shield 50 can vary in size depending on the size of the plant container and/or drain holes. One design consideration is that the size of the passages 80 between the supports 70 should be smaller than drain hole 22 in the plant container so that any material that passes through the passages 80 will be able to freely exit through the drain hole 22 to avoid clogging. In one embodiment, the width and height of the inlet end of the passages 80 is less than a diameter of the drain hole 22 in the plant container 20 for which it is designed.

Over the course of time a significant amount of material will make its way to the bottom of the plant container 20 and collect around the device, reducing its efficiency. Even with the many passages 80 for the water to egress out of the plant container 20, some may become clogged resulting in poor drainage. At that point, the obstructions will need to be cleared out by either placing the plant container 20 in a tub of water and moving it up and down a few times allowing water to enter the drain hole 22 and pushing through the passages 80 clearing them out. This process will also suspend undesirable silt that has collected on the bottom allowing it to drain out with excess water, restoring proper drainage. The bottom surface 56 of the cover plate 52 will divert the water through the passages 80 protecting the root ball from having precious nutrients from being washed out and preserve the capillary passages that have formed over time. The drain shield 50 will also help distribute fertilizer if one chose to bottom feed the plant occasionally, again keeping the root ball protected. Another option would be to tip the plant container 20 on its side and use a garden hose to clear the debris restoring drainage and aeration.

What is claimed is:

1. A drain shield for a plant container, the drain shield comprising:
a cover plate including a top surface and a bottom surface for covering a drain hole in a bottom of a plant container;
a plurality of supports downward extending from the bottom surface of the cover plate configured to support the cover plate in spaced relation to the bottom of the plant container to form a drainage chamber beneath the cover plate; and
a plurality of passages, each formed between an adjacent pair of supports to allow the flow of water into the drainage chamber.

2. The drain shield of claim 1 wherein the cover plate is generally circular in shape and the supports are circumferentially spaced adjacent an outer edge of the cover plate.

3. The drain shield of claim 2 wherein the supports are spaced inwardly from the outer edge of the cover plate and the outer edge of the cover plate forms an overhang above the supports.

4. The drain shield of claim 1 wherein the passages increase in size from an inlet end of the passageway to an outlet end of the passageway.

5. The drain shield of claim 1 wherein the bottom surface is concave and forms a dome above the drainage chamber.

6. A container system for plants, the container system comprising:
a plant container having side walls and a bottom for containing a planting medium, the bottom including at least one drain hole;
a drain pan for supporting the plant container and containing water that exits the drain hole in the plant container; and
a drain shield to cover the drain hole in the plant container, the drain shield comprising:
a cover plate including a top surface and a bottom surface for covering a drain hole in a bottom of a plant container;
a plurality of supports downward extending from the bottom surface of the cover plate configured to support the cover plate in spaced relation to the bottom of the plant container to form a drainage chamber beneath the cover plate; and
a plurality of passages, each formed between an adjacent pair of supports to allow the flow of water into the drainage chamber.

7. The container system of claim 6 wherein the cover plate is generally circular in shape and the supports are circumferentially spaced adjacent an outer edge of the cover plate.

8. The container system of claim 7 wherein the supports are spaced inwardly from the outer edge of the cover plate and the outer edge of the cover plate forms an overhang above the supports.

9. The container system of claim 6 wherein the passages increase in size from an inlet end of the passageway to an outlet end of the passageway.

10. The container system of claim 6 wherein the bottom surface is concave and forms a dome above the drainage chamber.
